(19) United States
(12) Patent Application Publication
(10) Pub. No.: US 2006/0186674 A1
(43) Pub. Date: Aug. 24, 2006

(54) Door lock apparatus

(75) Inventors: Makoto Suzumura, Chita-shi (JP); Akira Muramatsu, Chiryu-shi (JP); Sigeru Tanabe, Obu-shi (JP); Yukinobu Kunimatsu, Toyoake-shi (JP)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(73) Assignee: AISIN SEIKI KABUSHIKI KAISHA, Kariya-shi (JP)

(21) Appl. No.: 11/348,234

(22) Filed: Feb. 7, 2006

(30) Foreign Application Priority Data
Mar. 25, 2005 (JP) 2005-089427
Feb. 23, 2005 (JP) 2005-047497

(51) Int. Cl. E05C 3/06

(52) U.S. Cl. 292/216

(57) ABSTRACT

A door lock apparatus includes a housing for accommodating a latch mechanism for holding a vehicle door to a vehicle body, a lever mechanism actuated when a door handle is operated, a link mechanism for connecting the lever mechanism to the latch mechanism, the link mechanism having a first position for transmitting operational force from the lever mechanism to the latch mechanism and a second position for preventing transmission of the operational force from the lever mechanism to the latch mechanism, and a motor drive mechanism for changing the first and second positions of the link mechanism. The housing includes a first accommodating space for accommodating the motor drive mechanism and a second accommodating space adjacently provided to the first accommodating space for accommodating the latch mechanism and a water preventing portion is provided for preventing water from entering the first accommodating space from outside the housing.

### CROSS REFERENCE TO RELATED APPLICATIONS

This application is based on and claims priority under 35 U.S.C. § 119 to Japanese Patent Application 2005-047497, filed on Feb. 23, 2005 and Japanese Patent Application 2005-089427, filed on Mar. 25, 2005, the entire content of which is incorporated herein by reference.

### FIELD OF THE INVENTION

This invention generally relates to a door lock apparatus. More specifically, this invention pertains to a door lock apparatus applicable to a vehicle, or the like.

### BACKGROUND

Conventionally, a door lock apparatus includes a latch mechanism, a lever mechanism, a link mechanism, and a motor drive mechanism, or the like, provided in a housing (as disclosed in JP2003-314116A; document 1). The latch mechanism changes a state of the vehicle door to the vehicle body between a state where the vehicle door is retained to be closed and a state where the vehicle door is enabled to open. The lever mechanism is actuated when a door opening means such as a door handle, or the like, is operated, and actuates the latch mechanism. The link mechanism and the motor drive mechanism change the state of the door lock apparatus between an unlocked state where the latch mechanism can be actuated and a locked state where the latch mechanism cannot be actuated. In these mechanisms, because the motor drive mechanism is configured from an electric part, if the motor drive mechanism makes contact with water, the electric part will be short-circuited and the short will cause trouble. Accordingly, some waterproofing measures need to be made for the door lock apparatus.

Document 1 discloses a door lock apparatus including two covers (a first cover and a second cover) configuring a housing for protecting parts inside the housing. An edge of each cover is joined to an edge of other cover. Further, in order for inhibiting water from entering the housing through a joint portion of the first cover and the second cover, a third cover is integrally provided over the first cover. Thus, the joint portion is protected from water entering the housing from upper part of the housing. As described above, in the door lock apparatus disclosed in the document 1, water is inhibited from entering the housing from an upper part of the housing, and the water is inhibited from contacting the electric part.

However, in the door lock apparatus disclosed in the document 1, when an boundary end portion is highest in the third cover, when water reaches the boundary end portion, the water droplet moves and spreads along a peripheral end portion of the third cover, and reaches near the joint portion of the first cover and the second cover. In this case, the third cover cannot sufficiently work any more. Then, there can be a danger that water enters the housing through the joint portion of the first cover and the second cover and induces short-circuit of the electric part, or induces other adverse effects, and causes trouble of the door lock apparatus.

A need thus exists for a door lock apparatus, which can inhibit water from approaching and contacting an electric part in a housing with reliability. The present invention has been made in view of the above circumstances and provides such a door lock apparatus.

### SUMMARY OF THE INVENTION

According to an aspect of the present invention, a door lock apparatus includes a housing for accommodating a latch mechanism for holding a vehicle door to a vehicle body in a closed state, a lever mechanism actuated when a door handle provided inside or outside the vehicle door is operated, a link mechanism provided between the lever mechanism and the latch mechanism for connecting the lever mechanism to the latch mechanism, the link mechanism having a first position for transmitting operational force from the lever mechanism to the latch mechanism and a second position for preventing transmission of the operational force from the lever mechanism to the latch mechanism, and a motor drive mechanism for changing the first and second positions of the link mechanism. The housing includes a first accommodating space for accommodating the motor drive mechanism and a second accommodating space adjacently provided to the first accommodating space for accommodating the latch mechanism and a water preventing means is provided for preventing water from entering the first accommodating space from outside the housing.

### BRIEF DESCRIPTION OF THE DRAWINGS

The foregoing and additional features and characteristics of the present invention will become more apparent from the following detailed description considered with reference to the accompanying drawings, wherein:

FIG. 1 represents a schematic view illustrating a door lock apparatus according to an embodiment of the present invention installed in a vehicle door;

FIG. 2 represents a front view illustrating an inner structure of the door lock apparatus according to the embodiment of the present invention;

FIG. 3 represents a top view illustrating the door lock apparatus according to the embodiment of the present invention;

FIG. 4A represents a partial front view illustrating a partial structure of a door lock apparatus according to a second embodiment of the present invention;

FIG. 4B represents a partial top view of the door lock apparatus according to the second embodiment of the present invention;

FIG. 5 represents a front view of an opening portion formed at a first cover according to the embodiment of the present invention; and

FIG. 6 represents a front view of a lid member placed on the first cover according to the embodiment of the present invention.

### DETAILED DESCRIPTION

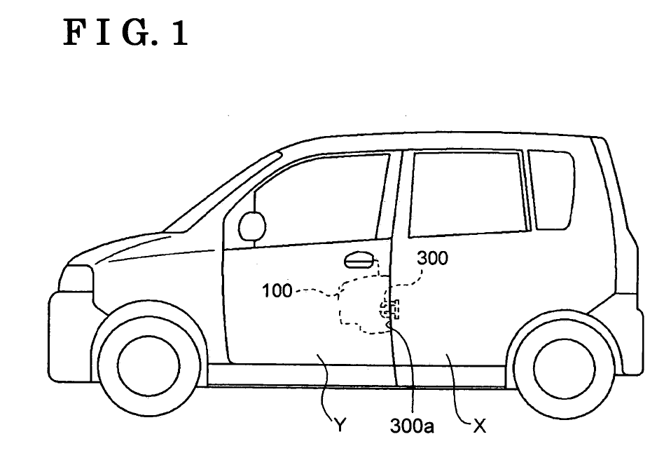

An embodiment of the present invention will be explained with reference to drawing figures. FIG. 1 represents a schematic diagram illustrating a door lock apparatus 100 according to the embodiment of the present invention. In FIG. 1, the door lock apparatus 100 is installed in a vehicle door Y. The door lock apparatus 100 is installed so as to face a striker 300 provided at a vehicle body X when the vehicle door Y is closed. A type of the vehicle door Y is not particularly limited. The vehicle door Y can be a hinge type door, a sliding door, or the like. Further, in FIG. 1, the door lock apparatus 100 is installed in a side door, serving as the vehicle door Y, for an occupant to get on and off a vehicle. However, it is not limited. The door lock apparatus 100 can be installed in a trunk lid of a hatchback.

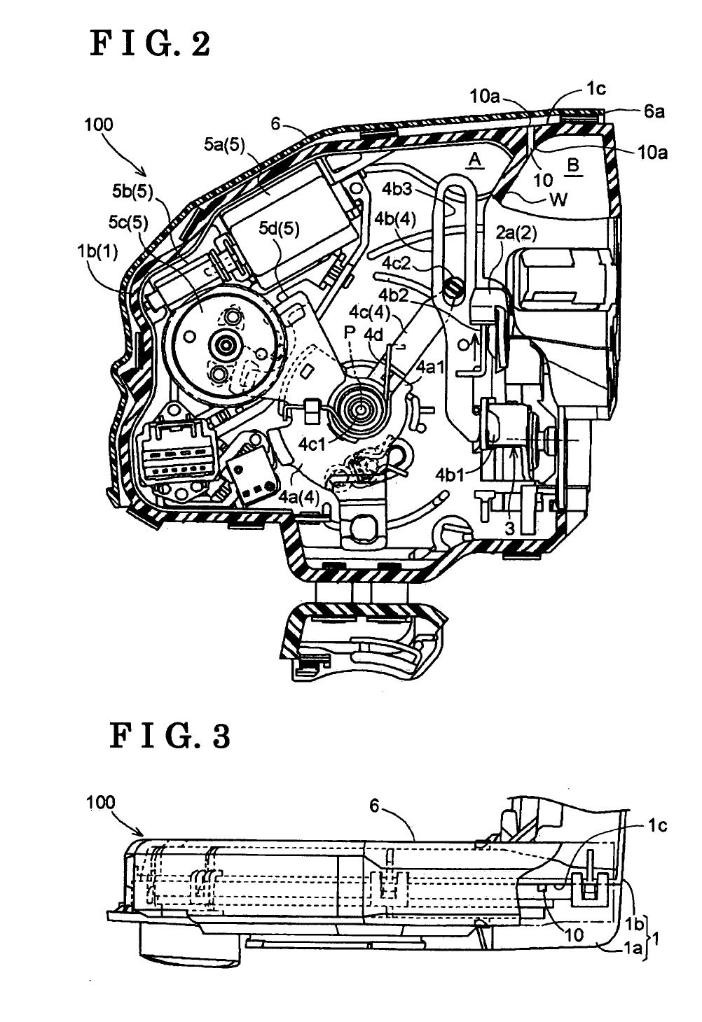

Structure of the door lock apparatus 100 will be explained. FIG. 2 represents a front view illustrating inner structure of the door lock apparatus 100 according to the embodiment of the present invention. FIG. 3 represents a top view of the door lock apparatus 100. The door lock apparatus 100 includes a latch mechanism 2, a lever mechanism 3, a link mechanism 4, and a motor drive mechanism 5, provided in a housing 1 made of resin or metal. The housing 1 includes a first cover 1a and a second cover 1b, each end is joined to other end to form a space inside thereof.

The latch mechanism 2 retains a closed state of the vehicle door Y, in which the door lock apparatus 100 is installed, to the vehicle body X. The latch mechanism 2 includes a guiding portion (not illustrated) for receiving the striker 300, a latch portion (not illustrated) for engaging with the striker 300, and a latch lever 2a. The latch portion is actuated by the striker 300, which makes contact with the latch portion in the guiding portion and presses the latch portion. For example, when an occupant closes the vehicle door Y, the latch portion of the latch mechanism 2 makes contact with the striker 300 provided at the vehicle body X and engages with the striker 300. Thus, the vehicle door Y is secured to the vehicle body X. Further, the latch portion is configured to cooperate with rotation of the latch lever 2a.

The lever mechanism 3 is operated by operation of a door handle (not illustrated) provided inside or outside of the vehicle door Y, and transmits operational force to the latch mechanism 2. For example, when the vehicle door Y is secured to the vehicle body X, if an occupant operates the door handle, the lever mechanism 3 is operated to release engagement of the latch portion of the latch mechanism 2 with the striker 300. Then, in this released state, if the vehicle door Y is pulled, the vehicle door Y can be opened.

The link mechanism 4 is provided between the lever mechanism 3 and the latch mechanism 2 for connecting the lever mechanism 3 to the latch mechanism 2. The link mechanism 4 can change a first and second position. In the first position, operational force is transmitted from the lever mechanism 3 to the latch mechanism 2. In the second position, transmission of the operational force is prevented. FIG. 2 represents a diagram illustrating an unlocked state in which the operational force can be transmitted from the lever mechanism 3 to the latch mechanism 2 (first position). The link mechanism 4 can be configured from plural members. Explanation of the link mechanism 4 will be made taking an example of a three-link structure configured from an active lever 4a, an open link 4b, and a sub lever 4c.

The active lever 4a, which is rotatable about a rotational shaft P, is driven by the motor drive mechanism 5 (described later). The active lever 4a includes a protruding portion 4a1 for biasing the sub lever 4c counterclockwise. Further, around the rotational shaft P of the active lever 4a, a spring 4d is provided for biasing the sub lever 4c clockwise.

The open link 4b includes an engaging portion 4b1 for engaging with the lever mechanism 3, a contacting portion 4b2 for making contact with the latch lever 2a of the latch mechanism 2, and a long hole portion 4b3. When an occupant operates the door handle and inputs operational force from the lever mechanism 3 to the engaging portion 4b1 of the open link 4b, the open link 4b moves in an upward direction of FIG. 2 (indicated by an arrow), the contacting portion 4b2 of the open link 4b starts pressing the latch lever 2a of the latch mechanism 2, the latch lever 2a rotates, and then engagement of the latch portion with the striker 300 is released. In other words, this is an unlocked state of the door lock apparatus 100. When an occupant stops operation of the door handle, the lever mechanism 3 pulls back the engaging portion 4b1 of the open link 4b, the contacting portion 4b2 of the open link 4b stops pressing the latch lever 2a, the latch lever 2a rotates in opposite direction and moves back to an original position, and the latch portion comes back to an initial state.

The sub lever 4c connects the active lever 4a to the open link 4b. Precisely, one end 4c1 of the sub lever 4c is secured to the rotational shaft P of the active lever 4a. The other end 4c2 is slidably fitted in the long hole portion 4b3 of the open link 4b.

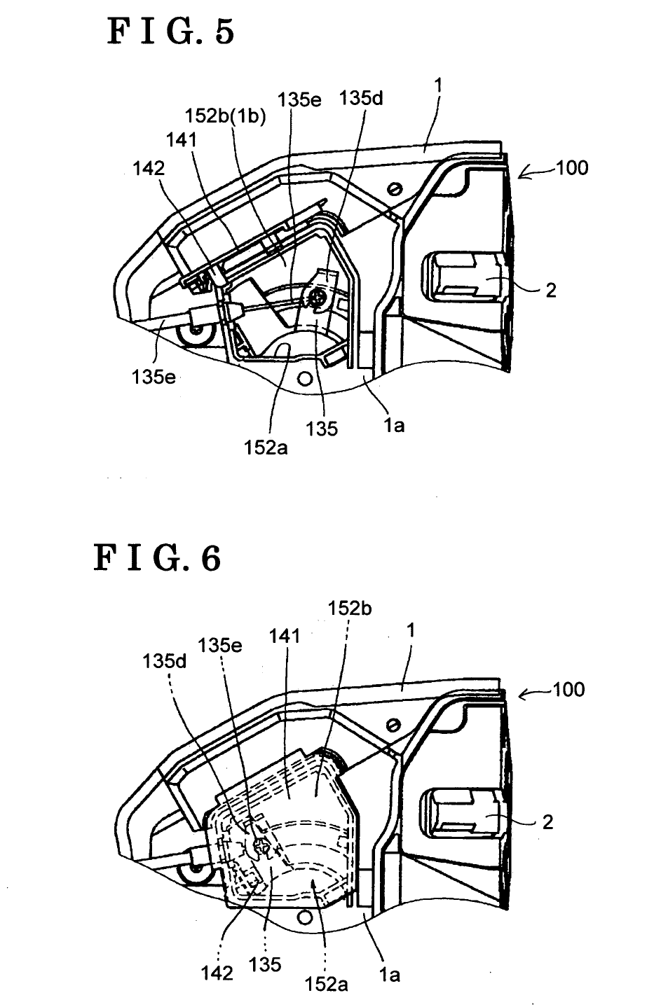

When the active lever 4a is driven by the motor drive mechanism 5 to rotate counterclockwise, the sub lever 4c is biased by the protruding portion 4a1 of the active lever 4a to rotate about the rotational shaft P counterclockwise. At this time, the other end 4c2 of the sub lever 4c slidably fitted in the long hole portion 4b3 of the open link 4b pulls the open link 4b to the left direction in FIG. 2. Thus, the contacting portion 4b2 of the open link 4b becomes out of contact with the latch lever 2a of the latch mechanism 2. In this state, when an occupant operates the door handle and transmits operational force to the lever mechanism 3, the open link 4b cannot transmit the operational force to the latch mechanism 2. In other words, transmission of the operational force from the lever mechanism 3 to the latch mechanism 2 is prevented. This is a locked state of the door lock apparatus 100. At the front side (as seen in FIG. 2) of the active lever 4a of the door lock apparatus 100 illustrated in FIG. 2, an inside open link 135d illustrated in FIG. 5 is superposed. The inside open link 135d slides along an introducing wall portion 152b formed on an outside of the first cover 1a. As the inside open link 135d moves, the active lever 4a illustrated in FIG. 2 moves. The inside open link 135d illustrated in FIG. 5 is connected to an inside door handle (not illustrated) through a cable 135e. Accordingly, when the inside door handle is operated, the active lever 4a illustrated in FIG. 2 is actuated through the cable 135e and the inside open link 135d. The first cover 1a of the housing 1 of the door lock apparatus 100, illustrated in FIG. 5, includes an opening portion 152a. Through the opening portion 152a, the cable 135e is connected to the inside open link 135d. As illustrated in FIG. 6, the opening portion 152a is covered by a lid member 141. Accordingly, malicious operation of the inside open link 135d by thieves can be inhibited. As illustrated in FIG. 5, the lid member 141 includes a protruding regulating portion 142. As illustrated in FIG. 6, when the lid member 141 covers the opening portion 152a, the regulating portion 142 regulates movable range of the inside open link 135d.

The motor drive mechanism 5 generates driving force for changing a position of the link mechanism 4. The motor drive mechanism 5 includes a motor portion 5a, a worm gear 5b, a wheel 5c, and an output portion 5d cooperating with the wheel 5c. The output portion 5d engages with the active lever 4a of the link mechanism 4. Structured as above, rotational driving force generated by the motor portion 5a can be transmitted to the active lever 4a through the worm gear 5b, the wheel 5c, and the output portion 5d.

Next, arrangement of parts in the housing will be explained. The latch mechanism 2, the lever mechanism 3, the link mechanism 4, and the motor drive mechanism 5 are provided in the housing 1. At the periphery of the housing 1, a joint portion of the first cover 1a and the second cover 1b is provided. Further, a cover member 6 is provided so as to cover the joint portion. The cover member 6 includes an end portion 6a at the latch mechanism 2 side.

Further, in the housing 1, a first accommodating space A and a second accommodating space B are provided. Areas of the first accommodating space A and the second accommodating space B are not definitely determined. The areas of the first accommodating space A and the second accommodating space B can be arbitrarily determined for convenience to some extent. In other words, as illustrated in FIG. 2, when a space is partially separated by a partial separating wall W, an approximate left side portion of the separating wall W can be the first accommodating space A, and an approximate right side portion of the separating wall W can be the second accommodating space B. It is needless to say that an inside space of the housing 1 can be completely separated into discrete compartments.

The reason why the inside space of the housing 1 is separated into two spaces as described above is to accommodate mainly electric parts of the door lock apparatus 100 in one of two spaces and to accommodate non-electric parts in the other of the two spaces. In the embodiment, in the first accommodating space A, at least the motor drive mechanism 5 is provided. In the second accommodating space B, at least the latch mechanism 2 is provided. As described above, an electric part, which is weak against water, such as the motor drive mechanism 5, is accommodated in the first accommodating space A. A non-electric part, which is relatively strong against water, such as the latch mechanism 2, is accommodated in the second accommodating space B. Further, providing a water preventing means, which will be explained below in an example, water proofing property of the door lock apparatus 100 can be ensured, and obtained in simple way. Accordingly, trouble of the door lock apparatus 100 caused by short or the like can be inhibited.

Next, a first embodiment will be explained. This embodiment is a door lock apparatus 100 explained above with reference to FIGS. 2 and 3. The door lock apparatus 100 includes, as a water preventing means, a hole 10 at the housing 1. Water flows through the hole 10 to the second accommodating space B. The housing 1 includes the first cover 1a and the second cover 1b. The hole 10 is formed at either the first cover 1a or the second cover 1b. The hole 10 is formed at the upper side of the housing 1. When the door lock apparatus 100 is installed in the vehicle, one end of the second accommodating space B (in other words, the latch mechanism 2) need to be exposed at an outside edge portion 300a of the vehicle door Y (illustrated in FIG. 1) because the door lock apparatus 100 need to engage with the striker 300 of the vehicle body X side. The door lock apparatus 100 is provided in the vehicle door Y. Through inside the vehicle door Y, water such as rainwater flows. Accordingly, water such as rainwater reaches the door lock apparatus 100 in the vehicle door Y, reaches the housing 1 from the end portion 6a of the cover member 6 illustrated in FIG. 2 through a clearance between the cover member 6 and the housing 1, and enters the housing 1 through a clearance between the first cover 1a and the second cover 1b illustrated in FIG. 3.

When water enters the clearance between the cover member 6 and the housing 1, the water starts flowing along an upper surface of the housing 1 illustrated in FIG. 2 toward a position above the first accommodating space A. However, because the door lock apparatus 100 in this embodiment has the hole 10 provided at the housing 1 in the middle of a water flow path 1c, the water enters the hole 10, and the water is introduced into the second accommodating space B. Accordingly, there cannot be a danger that water approaches or contacts an electric part such as the motor drive mechanism 5 in the first accommodating space A. Thus, trouble of the door lock apparatus 100 can be inhibited. Here, because a part accommodated in the second accommodating space B is a non-electric part such as the latch mechanism 2, trouble of the part in the second accommodating space B does not occur even when water directly contacts. The water having entered the second accommodating space B is discharged to outside the door lock apparatus 100 from a hole (not illustrated), or the like, appropriately provided at a lower part of the door lock apparatus 100.

The hole 10 can be preferably provided near the separating wall W, which defines the first accommodating space A and the second accommodating space B, at an upper portion of the housing at the second accommodating space B side. At this time, the separating wall W can be continuously connected to the hole 10. When the separating wall W and the hole 10 are arranged as described above, water entering the hole 10 can simply flow downward along the second accommodating space B side of the separating wall W, serving as an introducing means, into the second accommodating space B. Further, for simply introducing the water flowing along the upper surface of the housing 1, an inner periphery 10a of the hole 10 can be processed by means of round chamfering.

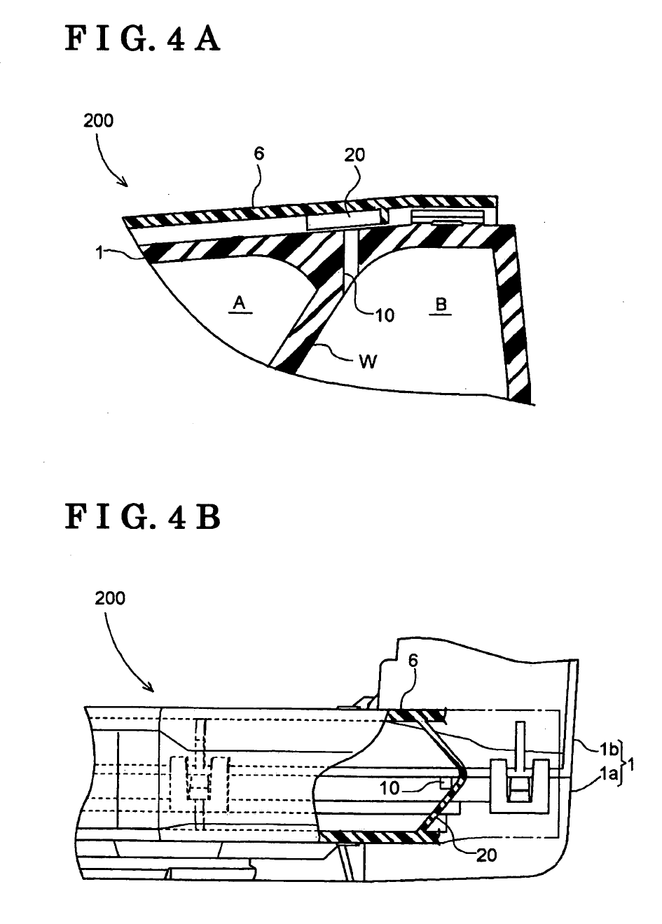

Next, a second embodiment will be explained. FIG. 4A represents a partial front view illustrating a partial structure of a door lock apparatus 200 according to a second embodiment of the present invention. FIG. 4B represents a partial top view illustrating the door lock apparatus 200. The door lock apparatus 200 according to this embodiment includes a V-shaped water stopping plate 20 in addition to the hole 10. Structure other than the water stopping plate 20 is the same as that of the door lock apparatus 100 according to the first embodiment.

The water stopping plate 20 can be provided on an upper surface side of the housing 1 in an area from an end portion of the cover member 6 to a position above the first accommodating space A. More specifically, the water stopping plate 20 can be provided near the upper surface of the housing 1 above the second accommodating space B. Water such as rainwater enters a clearance between the second accommodating space B side of the cover member 6 and the housing 1, flows along the upper surface of the housing 1, and flows toward a position above the first accommodating space A in the same way as in the first embodiment. However, the water stopping plate 20 inhibits the water from reaching the position above the first accommodating space A. Accordingly, approach and contact of water does not occur for an electric part such as the motor drive mechanism 5 in the first accommodating space A. Therefore, trouble of the door lock apparatus 200 can be inhibited.

The water stopping plate 20 can be directly provided on the upper surface of the housing 1. The water stopping plate 20 can also be integrally provided on a lower surface of the cover member 6 for covering the joint portion of the first cover 1a and the second cover 1b. In this case, the number of parts can be decreased and a process for placing the water stopping plate 20 can be eliminated. A lower end of the water stopping plate 20 and the upper surface of the housing 1 can be closely in contact. The lower end of the water stopping plate 20 and the upper surface of the housing 1 can be placed with a clearance therebetween to some extent. Even when a clearance is provided therebetween, water can be trapped in the clearance by effect of surface tension of the water. Accordingly, water can be inhibited from entering the first accommodating space A side of the clearance with reliability.

In this embodiment, in order for enhancing water-stopping effect, the water stopping plate 20 is provided in addition to the hole 10 according to the first embodiment. However, it is not limited. The stopping plate 20 can be solely provided as the water preventing means.

A door lock apparatus according to the embodiment of the present invention can be applied to a vehicle door. In addition, the door lock apparatus can be applied to a sunroof opening/closing apparatus, a hood opening/closing apparatus, or the like. In addition, application of the door lock apparatus is not limited to automotive industry. The door lock apparatus can be applied to anything having an opening/closing means, for example, a door for a building, a door of access opening of an electric appliance, or the like.

According to an aspect of the present invention, a door lock apparatus includes a housing for accommodating a latch mechanism for holding a vehicle door to a vehicle body in a closed state, a lever mechanism actuated when a door handle provided inside or outside the vehicle door is operated, a link mechanism provided between the lever mechanism and the latch mechanism for connecting the lever mechanism to the latch mechanism, the link mechanism having a first position for transmitting operational force from the lever mechanism to the latch mechanism and a second position for preventing transmission of the operational force from the lever mechanism to the latch mechanism, and a motor drive mechanism for changing the first and second positions of the link mechanism. The housing includes a first accommodating space for accommodating the motor drive mechanism and a second accommodating space adjacently provided to the first accommodating space for accommodating the latch mechanism and a water preventing means is provided for preventing water from entering the first accommodating space from outside the housing.

According to the aspect of the present invention, the first accommodating space and the second accommodating space are provided in the housing. The first accommodating space accommodates the motor drive mechanism. The second accommodating space accommodates the latch mechanism. In this situation, water preventing means prevents water entering the first accommodating space from outside the housing. Therefore, there cannot be a danger that water approaches and contacts an electric part such as the motor drive mechanism. Accordingly, trouble of the door lock apparatus can be inhibited.

According to a further aspect of the present invention, the water preventing means can be a hole provided at the housing for letting water flow into the second accommodating space.

According to the aspect of the present invention, water such as rainwater flows down the hole into the second accommodating space before the water reaches a position above the first accommodating space. Accordingly, there cannot be a danger that water approaches and contacts an electric part such as the motor drive mechanism in the first accommodating space. Therefore, trouble of the door lock apparatus can be inhibited.

According to a further aspect of the present invention, the water preventing means can be a water stopping plate provided near an upper surface of the housing above the second accommodating space.

According to the aspect of the present invention, water such as rainwater is blocked by the water stopping plate before the water moves to the position above the first accommodating space. Accordingly, there cannot be a danger that water approaches and contacts an electric part such as the motor drive mechanism in the first accommodating space. Therefore, trouble of the door lock apparatus can be inhibited.

According to a further aspect of the present invention, the door lock apparatus can further include a cover member for covering an upper surface side of the housing. The cover member has an end portion at the latch mechanism side. The water preventing means can be provided on or above the upper surface of the housing in an area from the end portion of the cover member to a position above the first accommodating space.

According to the aspect of the present invention, because the cover member for covering the upper surface side of the housing includes the end portion at the latch mechanism side, water such as rainwater enters from the position above the second accommodating space. When the water preventing means is provided on the upper surface side of the housing in an area from the end portion of the cover member to the position above the first accommodating space, the water preventing means can block the water between the cover member and the housing member from entering the position above the first accommodating space from the position above the second accommodating space with reliability.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. A door lock apparatus, comprising a housing for accommodating a latch mechanism for holding a vehicle door to a vehicle body in a closed state, a lever mechanism actuated when a door handle provided inside or outside the vehicle door is operated, a link mechanism provided between the lever mechanism and the latch mechanism for connecting the lever mechanism to the latch mechanism, the link mechanism having a first position for transmitting operational force from the lever mechanism to the latch mechanism and a second position for preventing transmission of the operational force from the lever mechanism to the latch mechanism, and a motor drive mechanism for changing the first and second positions of the link mechanism, wherein
the housing includes a first accommodating space for accommodating the motor drive mechanism and a second accommodating space adjacently provided to the first accommodating space for accommodating the latch mechanism and a water preventing means is provided for preventing water from entering the first accommodating space from outside the housing.

2. The door lock apparatus according to claim 1, wherein
the water preventing means includes a hole provided at the housing for letting water flow into the second accommodating space.

3. The door lock apparatus according to claim 1, wherein
the water preventing means includes a water stopping plate provided near an upper surface of the housing above the second accommodating space.

4. The door lock apparatus according to claim 1, wherein
the water preventing means includes at least one of a hole provided at the housing for letting water flow into the second accommodating space and a water stopping plate provided near an upper surface of the housing above the second accommodating space.

5. The door lock apparatus according to claim 1, further comprising a cover member for covering an upper surface side of the housing, the cover member having an end portion at the latch mechanism side, wherein
the water preventing means is provided on or above the upper surface of the housing in an area from the end portion of the cover member to a position above the first accommodating space.

6. The door lock apparatus according to claim 1, wherein
the first accommodating space and the second accommodating space are defined by a separating wall provided in the housing.

7. The door lock apparatus according to claim 6, wherein
the separating wall is continuously connected to the water preventing means.

8. The door lock apparatus according to claim 1, wherein
the water preventing means is provided at the second accommodating space side from a position between the first accommodating space and the second accommodating space.

9. The door lock apparatus according to claim 1, wherein
a water flow path is formed on the upper surface of the housing.

10. The door lock apparatus according to claim 1, wherein
one end of the housing at the second accommodating space side is exposed at an outside edge portion of the vehicle door.

11. The door lock apparatus according to claim 2, wherein
an inner periphery of the hole is processed by means of round chamfering.

12. The door lock apparatus according to claim 1, wherein
the water preventing means is an introducing means for introducing water into the second accommodating space.

13. The door lock apparatus according to claim 1, wherein
the housing includes an opening portion through which the lever mechanism and the door handle are linked.

14. The door lock apparatus according to claim 13, further comprising a lid member for covering the opening portion of the housing.

15. The door lock apparatus according to claim 14, wherein
the lid member includes a regulating portion for regulating movement of the lever mechanism.

16. The door lock apparatus according to claim 1, wherein
the water preventing means is provided on or above the housing.

17. The door lock apparatus according to claim 1, wherein
the housing includes a first cover and a second cover.

18. The door lock apparatus according to claim 17, wherein the water preventing means is provided at either one of the first cover and the second cover.

19. The door lock apparatus according to claim 2, further comprising a cover member for covering an upper surface side of the housing, the cover member having an end portion at the latch mechanism side, wherein
the water preventing means is provided on or above the upper surface of the housing in an area from the end portion of the cover member to a position above the first accommodating space.

20. The door lock apparatus according to claim 3, further comprising a cover member for covering the upper surface side of the housing, the cover member having an end portion at the latch mechanism side, wherein
the water preventing means is provided on or above the upper surface of the housing in an area from the end portion of the cover member to a position above the first accommodating space.
